(19) United States
(12) Patent Application Publication
(10) Pub. No.: US 2024/0405203 A1
(43) Pub. Date: Dec. 5, 2024

(54) AQUEOUS ELECTROCHEMICAL CELLS AND COMPONENTS THEREFOR

(71) Applicant: Alsym Energy, Inc., Woburn, MA (US)

(72) Inventors: Robert William Atkinson, Winchester, MA (US); Daniel Anthony Evans, Melrose, MA (US); Christopher Ryan Marsh, Waltham, MA (US); Alolika Mukhopadhyay, Wilmington, MA (US); David Wheeler, Allston, MA (US); Andres Badel, Cambridge, MA (US); Amir Chamaani, Watertown, MA (US); Blayne Phillips, Wilmington, MA (US); Rahul Mukherjee, Winchester, MA (US)

(21) Appl. No.: 18/670,120

(22) Filed: May 21, 2024

Related U.S. Application Data
(60) Provisional application No. 63/468,220, filed on May 22, 2023.

(51) Int. Cl. H01M 4/36; H01M 4/137; H01M 4/38; H01M 4/60; H01M 10/36

(52) U.S. Cl. CPC H01M 4/366; H01M 4/137; H01M 4/38; H01M 4/608; H01M 10/36

(57) ABSTRACT

Organic redox-active polymer-based electrodes for electrochemical cells and electrochemical cells (e.g., aqueous electrochemical cells) comprising them are presented herein. Additionally, methods of preparation of the same are presented.

### CROSS-REFERENCE TO RELATED APPLICATIONS

This application claims priority to and benefit of U.S. Provisional Application No. 63/468,220, filed on May 22, 2023, the entire contents of which are hereby incorporated by reference.

### TECHNICAL FIELD

This disclosure relates generally to aqueous electrochemical cells components therefor.

### BACKGROUND

Energy storage devices, such as electrochemical cells, generally include two electrodes (an anode and a cathode), a separator, and an electrolyte. These few components nonetheless present a complex electrochemical environment. The complex electrochemical environment can mar the performance of the electrochemical cell, for example through the occurrence of undesirable side reactions and/or electrochemical passivation, either at one or more of the electrodes, in the electrolyte, or between one or more of the electrodes and the electrolyte. There is a need, therefore, for electrode compositions that mitigate such undesirable side reactions and/or electrochemical passivation and/or promote electrochemical stability and/or kinetics in an energy storage device, such as an aqueous secondary battery.

### SUMMARY

Presented herein are components for use in aqueous electrochemical cells which are intended to provide for improved electrochemical cells which comprise various embodiments disclosed herein relative to conventional aqueous electrochemical cells. For example, disclosed embodiments may provide for, inter alia, improved electrochemical performance parameters including, but not limited to, charge storage capacity, cycling stability, and voltage stability window (e.g., between −1V vs. Ag/AgCl and +1V vs. Ag/AgCl; between −1.3V vs. Ag/AgCl and +1.3V vs. Ag/AgCl; between −1.6V vs. Ag/AgCl and +1.6V vs. Ag/AgCl; between 10° C. and 35° C.; between 0° C. and 40° C.; between −15° C. and +50° C.).

In some embodiments, the present disclosure is directed toward electrode compositions comprising an electrochemically-active polymer.

In some embodiments, an electrochemically-active polymer of disclosed electrode compositions has a formula of Formula I:

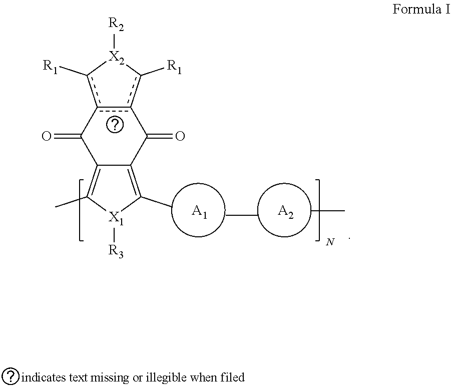

In some embodiments, wherein an electrochemically-active polymer has a formula of Formula I,
X₂ is nitrogen, oxygen, or sulfur;
R₁ is hydrogen, oxygen, an alkyl group, an alkoxy group, an aminoalkyl group, a thioalkyl group, or an acetyl group;
R₂ is hydrogen, an alkyl group, an aryl group, an alkylsulfonic acid group, an alkylphosphonic acid group, an alkylimidazolium group, an alkylpyridinium group, or an alkyl(trialkylammonium) group;
R₃ is hydrogen, an alkyl group, an alkylsulfonic acid group, an alkylphosphonic acid group, an alkylimidazolium group, an alkylpyridinium group, or an alkyl(trialkylammonium) group;
A₁ is a phenyl ring, a napthyl ring, an anthracene ring, a thiophene ring system, a furan ring system, a pyrrole ring system, a carbazole ring system, a fluorene ring system, a pyridine ring system, a benzothiadiazole ring system, a thieno[3,4-b]pyrazine ring system, a furo[3,4-b]pyrazine ring system, a benzo[2,1-b:3,4-b′]dithiophene-4,5-dione ring system, a quinoxaline ring system, a isoindoline-1,3-dione ring system, a pyrrolo[3,4-f]isoindole-1,3,5,7(2H,6H)-tetraone ring system, a benzo[lmn][3,8]phenanthroline-1,3,6,8(2H,7H)-tetraone ring system, a benzo[1,2-b:4,5-b′]difuran-4,8-dione ring system, a benzo[1,2-b:4,5-b′]dithiophene-4,8-dione ring system, a p-benzoquinone ring system, an o-benzoquinone ring system, a naphthalene-1,4-dione ring system, a phenanthrene-9,10-dione ring system, or a combination thereof; and
A₂ is absent or is a phenyl ring, a napthyl ring, an anthracene ring, a thiophene ring system, a furan ring system, a pyrrole ring system, a carbazole ring system, a fluorene ring system, a pyridine ring system, a benzothiadiazole ring system, a thieno[3,4-b]pyrazine ring system, a furo[3,4-b]pyrazine ring system, a benzo[2,1-b:3,4-b′]dithiophene-4,5-dione ring system, a quinoxaline ring system, a isoindoline-1,3-dione ring system, a pyrrolo[3,4-f]isoindole-1,3,5,7(2H,6H)-tetraone ring system, a benzo[lmn][3,8]phenanthroline-1,3,6,8(2H,7H)-tetraone ring system, a benzo[1,2-b:4,5-b′]difuran-4,8-dione ring system, a benzo[1,2-b:4,5-b′]dithiophene-4,8-dione ring system, a p-benzoquinone ring system, an o-benzoquinone ring system, a naphthalene-1,4-dione ring system, a phenanthrene-9,10-dione ring system, or a combination thereof.

In some embodiments, an electrochemically-active polymer of disclosed electrode compositions has a formula of Formula II:

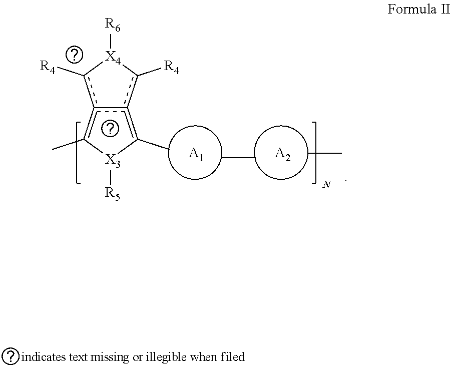

In some embodiments, wherein an electrochemically-active polymer has a formula of Formula H,
X₃ is nitrogen, oxygen, or sulfur;
X₄ is nitrogen, oxygen, or sulfur;
R₄ is hydrogen, oxygen, an alkyl group, an alkoxy group, an aminoalkyl group, a thioalkyl group, or an acetyl group;
R₆ is hydrogen, an alkyl group, an aryl group, an alkylsulfonic acid group, an alkylphosphonic acid group, an alkylimidazolium group, an alkylpyridinium group, or an alkyl(trialkylammonium) group;
R₅ is hydrogen, an alkyl group, an alkylsulfonic acid group, an alkylphosphonic acid group, an alkylimidazolium group, an alkylpyridinium group, or an alkyl(trialkylammonium) group;
A₁ is a phenyl ring, a napthyl ring, an anthracene ring, a thiophene ring system, a furan ring system, a pyrrole ring system, a carbazole ring system, a fluorene ring system, a pyridine ring system, a benzothiadiazole ring system, a thieno[3,4-b]pyrazine ring system, a furo[3,4-b]pyrazine ring system, a benzo[2,1-b:3,4-b′]dithiophene-4,5-dione ring system, a quinoxaline ring system, a isoindoline-1,3-dione ring system, a pyrrolo[3,4-f]isoindole-1,3,5,7(2H,6H)-tetraone ring system, a benzo[lmn][3,8]phenanthroline-1,3,6,8(2H,7H)-tetraone ring system, a benzo[1,2-b:4,5-b′]difuran-4,8-dione ring system, a benzo[1,2-b:4,5-b′]dithiophene-4,8-dione ring system, a p-benzoquinone ring system, an o-benzoquinone ring system, a naphthalene-1,4-dione ring system, a phenanthrene-9,10-dione ring system, or a combination thereof; and
A₂ is absent or is a phenyl ring, a napthyl ring, an anthracene ring, a thiophene ring system, a furan ring system, a pyrrole ring system, a carbazole ring system, a fluorene ring system, a pyridine ring system, a benzothiadiazole ring system, a thieno[3,4-b]pyrazine ring system, a furo[3,4-b]pyrazine ring system, a benzo[2,1-b:3,4-b′]dithiophene-4,5-dione ring system, a quinoxaline ring system, a isoindoline-1,3-dione ring system, a pyrrolo[3,4-f]isoindole-1,3,5,7(2H,6H)-tetraone ring system, a benzo[lmn][3,8]phenanthroline-1,3,6,8(2H,7H)-tetraone ring system, a benzo[1,2-b:4,5-b′]difuran-4,8-dione ring system, a benzo[1,2-b:4,5-b′]dithiophene-4,8-dione ring system, a p-benzoquinone ring system, an o-benzoquinone ring system, a naphthalene-1,4-dione ring system, a phenanthrene-9,10-dione ring system, or a combination thereof.

In another aspect, the present disclosure is directed toward electrode compositions for electrochemical cells, wherein disclosed electrode compositions comprise polymer-coated redox-active particles. In some embodiments, electrochemical cells are batteries, for example, secondary batteries.

In some embodiments, redox-active particles comprise a metal-containing species. In some embodiments, a metal-containing species is a halide, a hydroxide, an oxide, a phosphate, a suboxide, a nitrate, a nitrite, a sulfate, a sulfide, a chlorate, a bromate, or an iodate. In some embodiments, a metal-containing species is an elemental metal. In some embodiments, a metal-containing species comprises lithium, tin, zinc, tungsten, manganese, molybdenum, titanium, iron, vanadium, or a combination thereof.

In another aspect, the present disclosure is directed toward electrodes comprising any of the electrode compositions disclosed herein.

In another aspect, the present disclosure is directed toward electrochemical cells comprising any of the electrodes disclosed herein. In some embodiments, electrochemical cells are batteries, for example, secondary batteries.

In another aspect, the present disclosure is directed toward methods of operating electrochemical cells in a temperature range of −20° C. to 60° C., the methods comprising: absorbing or releasing heat into redox inactive materials inside the cells, absorbing or releasing heat into redox inactive materials outside the cells, inhibiting or improving one or more reactions via one or more catalysts and/or dopants in the cells, and/or controlling ionic conductivity at lower or higher temperature via one or more redox inactive electrode components in the cells.

In another aspect, the present disclosure is directed toward electrochemical cells comprising an electrode comprising a phase change additive. In some embodiments, electrochemical cells are batteries, for example, secondary batteries. In some embodiments, phase change additives are an encapsulated species.

In another aspect, the present disclosure is directed toward electrochemical cells comprising an electrode comprising a binder or emulsifier, wherein the binder or emulsifier is cross-linked or has been passivated such that the binder is stable at relatively higher temperature. In some embodiments, electrochemical cells are batteries, for example, secondary batteries.

In another aspect, the present disclosure is directed toward electrochemical cells comprising an electrode comprising redox active particles coated with a thermally stable encapsulant. In some embodiments, electrochemical cells are batteries, for example, secondary batteries. In some embodiments, a thermally stable encapsulant is a polymer, a ceramic, a metal, or a metal oxide.

Any two or more of the features described in this specification, including in this summary section, may be combined to form implementations not specifically explicitly described in this specification.

### BRIEF DESCRIPTION OF THE DRAWING

Drawings are presented herein for illustration purposes, not for limitation. The foregoing and other objects, aspects, features, and advantages of the disclosure will become more apparent and may be better understood by referring to the following description taken in conjunction with the accompanying drawings, in which:

FIG. 1 shows a graphical representation of exemplary aromatic heterocycles, according to illustrative embodiments of the present disclosure;

FIG. 2 shows a graphical representation of exemplary aromatic heterocycles according to illustrative embodiments of the present disclosure; and

FIG. 3 shows a graphical representation of exemplary redox-active polymers, according to illustrative embodiments of the present disclosure.

### DETAILED DESCRIPTION OF CERTAIN EMBODIMENTS

It is contemplated that systems, devices, methods, and processes of the disclosure encompass variations and adaptations developed using information from the embodiments described herein. Adaptation and/or modification of the systems, devices, methods, and processes described herein may be performed by those of ordinary skill in the relevant art.

Throughout the description, where articles, devices, and systems are described as having, including, or comprising specific components, or where processes and methods are described as having, including, or comprising specific steps, it is contemplated that, additionally, there are articles, devices, and systems according to certain embodiments of the present disclosure that consist essentially of, or consist of, the recited components, and that there are processes and methods according to certain embodiments of the present disclosure that consist essentially of, or consist of, the recited processing steps.

It should be understood that the order of steps or order for performing certain action is immaterial so long as operability is not lost. Moreover, two or more steps or actions may be conducted simultaneously. As is understood by those skilled in the art, the terms “over”, “under”, “above”, “below”, “beneath”, and “on” are relative terms and can be interchanged in reference to different orientations of the layers, elements, and substrates included in the present disclosure. For example, a first layer on a second layer, in some embodiments means a first layer directly on and in contact with a second layer. In some embodiments, a first layer on a second layer can include another layer there between.

Headers are provided for the convenience of the reader and are not intended to be limiting with respect to the claimed subject matter.

In this application, unless otherwise clear from context or otherwise explicitly stated, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; (iv) the terms “about” and “approximately” may be understood to permit standard variation as would be understood by those of ordinary skill in the relevant art; and (v) where ranges are provided, endpoints are included. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

### I. Electrolytes and Associated Components for Aqueous Electrochemical Cell

a. Electrolytes for Electrochemical Cells that Facilitate the Transport of Active Ions

Electrolytes for energy storage systems are herein described. In some embodiments, a battery comprises an electrolyte that relies on the transfer of positively charged hydrogen ions (hereafter referred to as “hydrogen ions”) from or to at least one electrode during cycling.

In some embodiments, electrodes may comprise a redox active compound. In some embodiments, electrodes may contain at least one of aluminum, titanium, vanadium, manganese, iron, zinc, niobium, indium, lithium, sodium, potassium, calcium, molybdenum, tin, bismuth, or tungsten. In some embodiments, electrolytes contains water. In some embodiments, electrolytes may contain ions, organic additives, inorganic additives, and/or cosolvents meant to facilitate the transfer of at least one of aluminum, vanadium, manganese, iron, zinc, hydrogen, lithium, sodium, potassium, calcium, molybdenum, tin, bismuth, or tungsten from or to at least one electrode. In some embodiments, electrodes may reversibly store one or more ions during cycling (for example, storing a manganese ion; storing a hydrogen ion; storing a zinc ion). In some embodiments, electrolytes may contain components that facilitate reversible storage of the ion or ions into electrodes (for example, facilitate reversible storage of manganese ions; facilitate reversible storage of hydrogen ions; facilitate reversible storage of zinc ions). Reversible storage can be described as intercalation/de-intercalation, chemical bonding, van der Waals bonding, or any other mechanism by which the ions are stored within and released from electrodes during electrochemical cycling.

In some embodiments, the ions may facilitate the conversion of one material to a second material during cycling. In some embodiments, electrolytes may contain a buffer system to stabilize the pH of electrolytes during cycling. In some embodiments, electrolytes contains a redox mediator. In some embodiments, electrolytes contains both a buffer system and at least one redox mediator. In some embodiments, a redox mediator functions as a buffer.

b. Redox Mediator for Energy Storage Devices with Aqueous Electrolytes

Electrolytes with redox mediators incorporated into energy storage systems are described. Redox mediators may shuttle electrons (accepting or donating) between the current collector and reactants in electrolytes, providing additional pathways for an electrochemical reaction.

In some embodiments, electrolytes for energy storage systems contain redox mediators as additives along with other components such as other additives, salts, and solvents. These solvents can be aqueous, non-aqueous, or aqueous/non-aqueous cosolvents. A redox mediator facilitates one or more reactions (conversion, deposition/dissolution, plating and stripping, and/or intercalation) on either or both electrodes during cell operations.

Redox mediators may improve several cell performance metrics including cycling stability, round-trip efficiency, Coulombic efficiency, accessible capacity, charge stability, and cell voltage by either altering the activation barrier of the primary redox reaction or through chemical/electrochemical interaction with the primary redox reactions on either or both electrodes.

A redox mediator incorporated into electrolytes may include an organic, organometallic, inorganic compound, or a combination thereof. Redox mediator compounds that have redox potentials between the thermodynamic potentials of the positive and negative electrodes have been chosen such that a redox mediator is chemically and electrochemically stable during cell operations.

Depending on the physicochemical properties of redox mediators, they could be added to electrolytes at various pHs and temperatures to form solutions, emulsions, suspensions, slurries, or some combination therein. In some embodiments, a solid species comprising one or more of redox mediators is added to one or both electrodes that then dissolve into electrolytes over time (for example, during cycling of the energy storage device).

In some embodiments, a redox mediator-containing electrolytes may undergo ex-situ or in-situ electrochemical activation prior to cell operation.

In some embodiments, potentially detrimental impacts of redox mediators, such as shuttling of redox mediators between electrodes, are minimized by cell engineering strategies. Some of these strategies include but are not limited to the isolation of redox mediators to a specific part of a cell using an ion-selective separator (e.g., negatively or positively charged polymer, metal-organic framework (MOF), ion-conducting ceramics, polymers of intrinsic microporosity), cell design, the use of protective coatings (e.g. PANI), and the use of surface treatments.

Examples of inorganic redox mediators include, but are not limited to, metal halide salts such as bromide, iodide, chloride, and their combination, metal trihalide salts such as tribromide, triiodide, iodine dibromide, iodine dichloride, bromine dichloride, bromine diiodide, and their combination, Cr²⁺/Cr³⁺, V³⁺/V⁴⁺, V⁴⁺/V⁵⁺, Fe²⁺/Fe³⁺ and Ce³⁺/Ce⁴⁺.

Examples of organic redox mediators include, but are not limited to, TTF, TEMPO, Methoxy-TEMPO, 1-Me-AZADO, MPT, DMPZ, TDPA, DBBQ, FePc, tb-CoPc, Co(Terp)2, Heme, Co(tris[4-(diethylamino)phenyl]amine), dimethylphenazine (DMPZ), 2-phenyl-4,4,5,5-tetramethylimidazoline-1-oxyl-3-oxide (PTIO), PANI, polymerized redox mediators (e.g., polyanthraquinone, polymers with chemically-bonded halide layers), AQDS, phosphate salts, and carboxylic salts such as acetates and formates and their combination.

Redox mediators may be added to electrolytes at a concentration that ranges, for instance, in the ranges from 1 μM to 10 μM (e.g., about 1 μM, about 5 μM, about 10 μM, about 100 μM, about 250 μM, about 500 μM, about 1M, about 2M, about 3M, about 4M, about 5M, or about 10M) at different pH ranges including from 0 to 3, 0 to 7, 3-7, 3-10, 10-14, 7-14 or 0-14 and temperatures from 0-30° C. (e.g., about 0° C., about 5° C., about 10° C., about 15° C., about 20° C., about 25° C., or about ° C.), 25-50° C. (e.g., about 25° C., about 30° C., about 35° C., about 40° C., about 45° C., about 50° C.), or 50-100° C. (e.g., about 50° C., about 55° C., about 60° C., about 65° C., about 70° C., about 75° C., about 80° C., about 85° C., about 90° C., about 95° C., or about 100° C.).

II. Organic-Based, Redox-Active Polymers and their Uses in Secondary Battery Systems

Herein describes organic polymers for use as electrodes in secondary battery systems. In some embodiments, electrodes comprises an electrochemically-active polymer (hereafter referred to as “redox-active polymer”). In some embodiments, the redox-active polymer may be organic or organometallic in composition. In some embodiments, the redox active groups are embedded in the polymer, including but not limited to the conjugated polymer. In some embodiments, the polymer bears redox active pendant groups which may or may not be grafted to the structure. In some embodiments, the redox-active polymer will accept or provide electrons to facilitate the reduction and/or oxidation of the polymer, respectively. In some embodiments, the redox-active polymer will transfer, store, and/or release monovalent or multivalent ions during electrochemical cycling. In some embodiments, the redox-active polymer will transfer, store, and/or release cations such as, but not limited to lithium ions, sodium ions, potassium ions, cesium ions, hydrogen ions, zinc ions, aluminum ions, magnesium ions, calcium ions, and/or barium ions during electrochemical cycling.

In some embodiments, the redox-active polymers may be of the following classifications: linear, branched, or cross-linked. The redox-active polymers may be of the following sub-classifications: homopolymers, alternating co-polymers, periodic co-polymers, random co-polymers, block co-polymers, graft co-polymers, gradient co-polymers. In some embodiments, the redox-active polymers contain redox active groups are embedded in the redox-active polymer backbone, including, but not limited to conjugated polymers. In some embodiments, the redox-active polymer backbone exhibits no redox active qualities, but bears pendant redox active groups which may or may not be grafted and/or linked to the polymer backbone. In some embodiments, the redox-active polymer may bear redox active groups in the polymer backbone and pendant redox active groups which may or may not be grafted and/or linked to the polymer backbone.

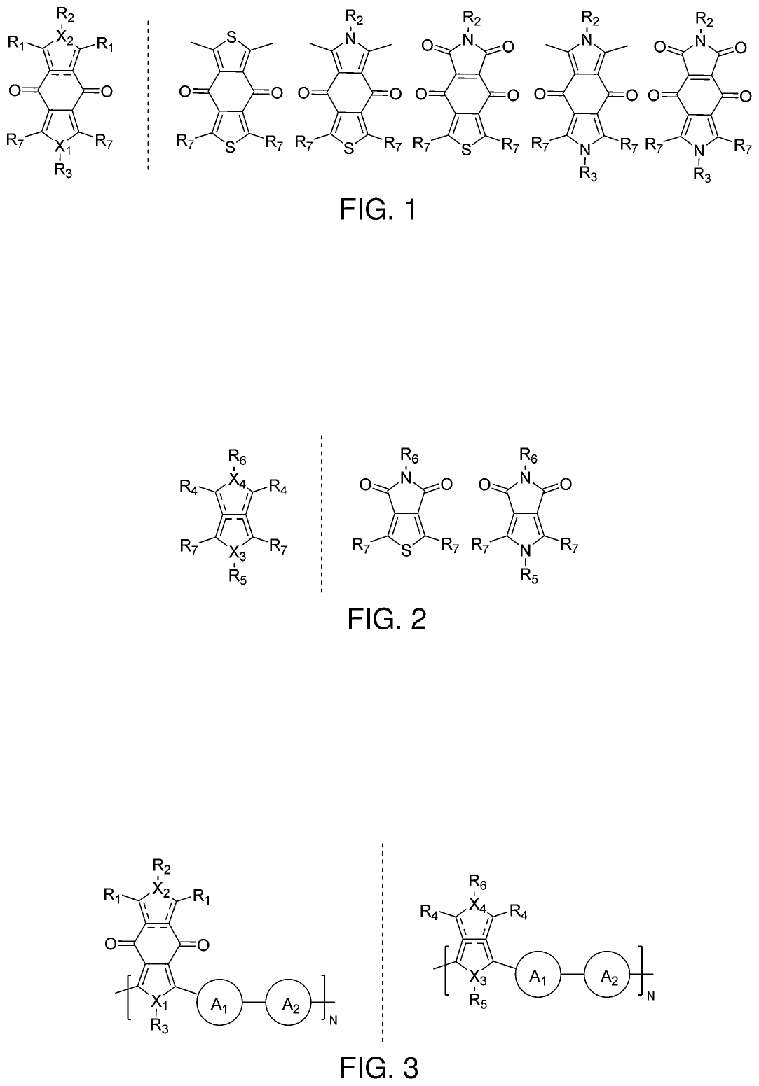

In some embodiments, the redox-active polymer may, but is not required to, include one or more aromatic heterocycles shown in FIG. 1. In some embodiments, the aromatic units may be linked to another non-substituted or substituted aromatic ring at any position such as, but not limiting to: a benzene ring, a naphthalene ring, an anthracene ring, a thiophene ring system, a furan ring system, a pyrrole ring system, a carbazole ring system, a fluorene ring system, a pyridine ring system, a benzothiadiazole ring system, a thieno[3,4-b]pyrazine ring system, a furo[3,4-b]pyrazine ring system, a benzo[2,1-b:3,4-b′]dithiophene-4,5-dione ring system, a quinoxaline ring system, a isoindoline-1,3-dione ring system, a pyrrolo[3,4-f]isoindole-1,3,5,7(2H,6H)-tetraone ring system, a benzo[lmn][3,8]phenanthroline-1,3,6,8(2H,7H)-tetraone ring system, a benzo[1,2-b:4,5-b′]difuran-4,8-dione ring system, a benzo[1,2-b:4,5-b′]dithiophene-4,8-dione ring system, a p-benzoquinone ring system, a o-benzoquinone ring system, a naphthalene-1,4-dione ring system, a phenanthrene-9,10-dione ring system. In some embodiments, the aromatic units may be covalently bonded to materials such as, but not limiting to: an ethyl group, a propyl group, a butyl group, a hexyl group, a glycol group, an imine group, and a sulfonyl group.

In some embodiments, the redox-active polymers may, but are not required to, include one or more aromatic heterocycles shown in FIG. 2. In some embodiments, the aromatic units may be linked to another non-substituted or substituted aromatic ring at any position such as, but not limiting to: a benzene ring, a naphthalene ring, an anthracene ring, a thiophene ring system, a furan ring system, a pyrrole ring system, a carbazole ring system, a fluorene ring system, a pyridine ring system, a benzothiadiazole ring system, a thieno[3,4-b]pyrazine ring system, a furo[3,4-b]pyrazine ring system, a benzo[2,1-b:3,4-b′]dithiophene-4,5-dione ring system, a quinoxaline ring system, a isoindoline-1,3-dione ring system, a pyrrolo[3,4-f]isoindole-1,3,5,7(2H,6H)-tetraone ring system, a benzo[lmn][3,8]phenanthroline-1,3,6,8(2H,7H)-tetraone ring system, a benzo[1,2-b:4,5-b′]difuran-4,8-dione ring system, a benzo[1,2-b:4,5-b′]dithiophene-4,8-dione ring system, a p-benzoquinone ring system, a o-benzoquinone ring system, a naphthalene-1,4-dione ring system, a phenanthrene-9,10-dione ring system. In some embodiments, the aromatic units may be covalently bonded to: aliphatic materials such as, but not limiting to an ethyl group, a propyl group, a butyl group, a hexyl group, a glycol group, an imine group, and a sulfonyl group.

FIG. 3 presents exemplary compositions redox-active polymers. In some embodiments, X₁ and/or X₃ may be, but is not limited to, a nitrogen, an oxygen, or a sulfur atom. In some embodiments, X₂ and/or X₄ may be, but is not limited to a nitrogen, an oxygen, or a sulfur atom. In some embodiments, R₁ and/or R₄ may be, but is not limited to: a hydrogen atom or an oxygen atom, an alkyl group, an alkoxy group, an aminoalkyl group, a thioalkyl group, or an acetyl group. In some embodiments, R₂ and/or R₆ may be, but is not limited to: a hydrogen atom, an alkyl group, an aryl group, an alkylsulfonic acid group, an alkylphosphonic acid group, an alkylimidazolium group, an alkylpyridinium group, or an alkyl(trialkylammonium) group. In some embodiments, R₃ or R₅ may be, but is not limited to a hydrogen atom, an alkyl group, an alkylsulfonic acid group, an alkylphosphonic acid group, an alkylimidazolium group, an alkylpyridinium group, or an alkyl(trialkylammonium) group. In some embodiments, A₁ may be, but is not limited to: a phenyl ring, a napthyl ring, an anthracene ring, a thiophene ring system, a furan ring system, a pyrrole ring system, a carbazole ring system, a fluorene ring system, a pyridine ring system, a benzothiadiazole ring system, a thieno[3,4-b]pyrazine ring system, a furo[3,4-b]pyrazine ring system, a benzo[2,1-b:3,4-b′]dithiophene-4,5-dione ring system, a quinoxaline ring system, a isoindoline-1,3-dione ring system, a pyrrolo[3,4-f]isoindole-1,3,5,7(2H,6H)-tetraone ring system, a benzo[lmn][3,8]phenanthroline-1,3,6,8(2H,7H)-tetraone ring system, a benzo[1,2-b:4,5-b′]difuran-4,8-dione ring system, a benzo[1,2-b:4,5-b′]dithiophene-4,8-dione ring system, a p-benzoquinone ring system, a o-benzoquinone ring system, a naphthalene-1,4-dione ring system, a phenanthrene-9,10-dione ring system. In some embodiments, A₂ may be, but is not limited to: a phenyl ring, a napthyl ring, an anthracene ring, a thiophene ring system, a furan ring system, a pyrrole ring system, a carbazole ring system, a fluorene ring system, a pyridine ring system, a benzothiadiazole ring system, a thieno[3,4-b]pyrazine ring system, a furo[3,4-b]pyrazine ring system, a benzo[2,1-b:3,4-b′]dithiophene-4,5-dione ring system, a quinoxaline ring system, a isoindoline-1,3-dione ring system, a pyrrolo[3,4-f]isoindole-1,3,5,7(2H,6H)-tetraone ring system, a benzo[lmn][3,8]phenanthroline-1,3,6,8(2H,7H)-tetraone ring system, a benzo[1,2-b:4,5-b′]difuran-4,8-dione ring system, a benzo[1,2-b:4,5-b′]dithiophene-4,8-dione ring system, a p-benzoquinone ring system, a o-benzoquinone ring system, a naphthalene-1,4-dione ring system, a phenanthrene-9,10-dione ring system. In some embodiments, A₁ and A₂ may be any combination of the aforementioned ring systems. In some embodiments, A₂ may not be present in the system.

Processing of a redox-active polymer into an active electrode are described along with electrode function and fabrication. An electrode may be designed as either an anode or a cathode in a secondary battery system. In some embodiments, an electrode may comprise a current collector, a redox-active polymer, conductive additives, and one or more polymer additives. In some embodiments, the current collector used may be, but is not limited to, titanium, zirconium, aluminum, copper, nickel, carbon, graphite, graphene, and stainless steel. In some embodiments, polymer additives used may be, but are not limited to, styrene-butadiene rubber, poly(vinylidene fluoride), poly(tetrafluoroethylene), sulfonated poly(tetrafluoroethylene) (Nafion), carboxymethyl cellulose, carboxyethyl cellulose, hydroxyethyl cellulose, hydroxypropyl cellulose, polyacrylic acid, or poly(methyl methacrylate).

In some embodiments, the active material for electrodes in a secondary battery system may be processed by means of solid-state processing, slurry processing, chemical or electrochemical polymerization, or thermal evaporation. In some embodiments, slurry deposition to the current collector may be performed by means of drawdown coating, slot-die coating, reverse roll coating, gravure coating, knife-over-roll coating, comma coating, electrospinning, or any other method of coating known to those skilled in the art. In some embodiments, solid-state processing to the current collector may be performed. In some embodiments, the redox-active polymer may undergo ex-situ or in-situ electrochemical activation prior to cell fabrication and/or operation. In some embodiments, one or both of electrodes in the energy storage system may contain redox-active polymer materials as the active layer.

The components of the secondary battery energy storage system electrolyte are described while in no way limiting the mechanism or theory of the system. In some embodiments, electrodes may be introduced into an electrolytic solution which may contain any one or more stereoisomeric combination of hydrogen ion donor materials such as, but not limiting to: acetic acid, benzoic acid, formic acid, gluconic acid, oxalic acid, oxamic acid, oxalamide, butanedioic acid, 2-hydroxybutanedioic acid, 2-hydroxypropane-1,2,3-tricarboxylic acid 2-hydroxypropanoic acid, 2,3-dihydroxybutanedioic acid, (2E)-but-2-enoic acid, pyridine-2-carboxylic acid, pyridine-2,6-dicarboxylic acid, pyridine-3-carboxylic acid, pyridine-3,5-dicarboxylic acid, pyridine-4-carboxylic acid, (methylamino)acetic acid, (dimethylamino)acetic acid, pyridine-2-sulfonic acid, pyridine-3-sulfonic acid, pyridin-2-ylmethylamine, pyridin-3-ylmethylamine, amino(oxo)methanesulfonic acid, 2-oxo-2-(phenylamino)acetic acid, N1-phenyloxalamide, oxo(phenylamino)methanesulfonic acid, L-Arginine, L-Histidine, L-Alanine, L-Proline, aminoacetic acid, succinic acid, lactic acid, mandelic acid, itaconic acid, tartaric acid, citric acid, phosphoric acid, boric acid, sulfuric acid, nitric acid, phosphoric acid hydrochloric acid, hydrobromic acid, hydroiodic acid, or salts of aluminum, vanadium, manganese, iron, copper, aluminum, zinc, gallium, bismuth, or any other organic acids, inorganic acids, or metal salts which liberate a metal ion possessing properties of a classical, Lewis, or Bronsted acid. In some embodiments, electrodes may be introduced into an electrolytic solution which may contain any one or more stereoisomeric combination of hydrogen ion acceptor materials such as, but not limiting to: sodium hydroxide, potassium hydroxide, lithium hydroxide, ammonium hydroxide, manganese hydroxide, calcium hydroxide, pyridine, piperdine, methoxides, tert-butoxides, ammonium, alkylamines, dialkylamines, trialkylamines, arylamines, diarylamines, or triarylamines.

In some embodiments, electrodes may be introduced into an electrolytic solution which may contain inorganic or organic salts, where the cation composition may be, but is not limited to: lithium, sodium, potassium, cesium, magnesium, calcium, barium, zirconium, vanadium, chromium, molybdenum, tungsten, manganese, iron, cobalt, iridium, nickel, copper, silver, gold, zinc, aluminum, phosphonium, ammonium, tetraalkylammonium, imidazolium, pyridinium, and isoquinolinium ions. In some embodiments, electrodes may be introduced into an electrolytic solution which may contain inorganic or organic salts, where the anion composition may be, but is not limited to, sulfate, sulfonates, phosphates, acetate, formates, nitrate, hexavalent phosphates, carbonates, hydroxides, fluorides, chlorides, bromides, iodides, trifluoromethanesulfonate, and bis(trifluoromethane)sulfonimide. In some embodiments, the solvent used to make electrolytes may be water. In some embodiments, the solvents used to make electrolytes may be organic in nature, where examples include, but are not limited to: ethanol, isopropanol, methanol, sulfolane, Diethyl ether, N-methylpyrrolidone, acetonitrile, N,N-dimethylformamide, N,N-dimethylacetamide, tetrahydrofuran, ethylene carbonate, dimethyl carbonate, and propylene carbonate. In some embodiments, electrolytes may contain redox active polyionic compounds bearing redox active organic and organometallic materials such as, but not limiting to: ferrocene acetic acid; 4-nitrobenzoic acid; 4-nitrophenylacetic acid; salicylhydroxamic acid; 2,5-dihydroxybenzoic acid; or 2, 3-dihydroxybenzoic acid. In some embodiments, the redox active polyionic compounds may be ionically or coulombically coordinated with materials such as, but not limiting to: ammonia, alkylamines, dialkylamines, trialkylamines, arylamines, diarylamines, triarylamines, fluorides, chlorides, bromides, iodides.

Redox-active polymers of the present disclosure may improve certain characteristics of the energy storage system. Improved cell characteristics may include but are not limited to higher average discharge voltage, longer cycle life, higher specific capacity, improved voltaic efficiency, improved coulombic efficiency, or improved rate capability.

III. Organic-Based, Redox-Active Polymers and their Uses in Secondary Battery Systems

Polymer-coated metal containing redox-active particles for use as redox-active materials in secondary battery systems electrodes is described. In some embodiments, electrodes comprise a conductive or semi-conductive polymer which is mechanically applied to the redox-active particles through engineering methods or grown via a chemical reaction(s) on the surface of the particles. In some embodiments, the polymer may be organic or organometallic in composition.

The redox-active particles of the polymer redox-active particles are described. In some embodiments, the metal composition of the redox-active particle may be, but is not limited to: lithium, tin, zinc, tungsten, manganese, molybdenum, titanium, iron, vanadium, or some combination thereof. The metal may be present as halides, hydroxides, oxides, phosphates, suboxides, nitrates, nitrites, sulfates, sulfides, chlorates, bromates, iodates, or elements. In some embodiments, the redox-active particles may be doped with metals such as, but not limited to, aluminum, yttrium, tin, copper, cobalt, zinc, silver, gold, iron, chromium, sodium, potassium, cesium, magnesium, calcium, or barium. In some embodiments, the doping concentration may be less than 15%. In some embodiments, the particle size of the redox active particle may have a particle size distribution where the d99 is less than 100 microns.

In some embodiments, the polymers of the polymer-coated redox-active particles may be of the following classifications: linear, branched, or cross-linked. In some embodiments, the polymers of the polymer-coated redox-active particles may be of the following sub-classifications: homopolymers, alternating co-polymers, periodic co-polymers, random co-polymers, block co-polymers, graft co-polymers, gradient co-polymers. In some embodiments, the polymers of the polymer-coated redox-active particles may be applied to the redox active particle in thicknesses ranging between, but are not limited to, 2 nm-50,000 nm. In some embodiments, the polymers may include, but are not required to include, one or more aromatic heterocyclic monomers. In some embodiments, the polymers of the polymer-coated redox-active particles include, but are not limited to, homopolymers. In some embodiments, monomers used to form the polymer of the polymer-coated redox-active particles may be, but are not limited to, the following in composition: linear hydrocarbons, perfluorinated hydrocarbons, substituted hydrocarbons, cyclic hydrocarbons, cyclic perfluorinated hydrocarbons, substituted hydrocarbons, linear alkenes, linear perfluoronated alkenes, linear substituted alkenes, linear alkynes, aromatic heterocycles, or substituted aromatic heterocycles or combinations thereof. Examples of aromatic units may be, but are not limited to: a phenyl ring, a naphthyl ring, an anthracene ring, a thiophene ring system, a furan ring system, a pyrrole ring system, a carbazole ring system, a fluorene ring system, a pyridine ring system, a benzothiadiazole ring system, a thieno[3,4-b]pyrazine ring system, a furo[3,4-b]pyrazine ring system, a benzo[2,1-b:3,4-b′]dithiophene-4,5-dione ring system, a quinoxaline ring system, a isoindoline-1,3-dione ring system, a pyrrolo[3,4-f]isoindole-1,3,5,7(2H,6H)-tetraone ring system, a benzo[lmn][3,8]phenanthroline-1,3,6,8(2H,7H)-tetraone ring system, a benzo[1,2-b:4,5-b′]difuran-4,8-dione ring system, a benzo[1,2-b:4,5-b′]dithiophene-4,8-dione ring system, a p-benzoquinone ring system, a o-benzoquinone ring system, a naphthalene-1,4-dione ring system, a phenanthrene-9,10-dione ring system. In some embodiments, the monomers, polymers, or copolymers may include, but are not limited to, pyrrole, thiophene, and aniline. In some embodiments, the alkyl units may be covalently bonded to materials such as, but not limiting to: an ethyl group, a propyl group, a butyl group, a hexyl group, a glycol group, an imine group, and a sulfonyl group.

The substitution of the polymers is described. In some embodiments, the substitution of the alkyl monomers may include, but are not limited to, any one or combination of the following: a hydrogen atom, linear hydrocarbons, perfluorinated hydrocarbons, cyclic hydrocarbons, cyclic perfluorinated hydrocarbons, alkoxy-groups, alkyl-sulfide groups, monoalkyl-amines, dialkyl-amines, alkylsulfonic acid groups, alkylphosphonic acid groups, alkylimidazolium groups, alkylpyridinium groups, or alkyl(trialkylammonium) groups, linear alkenes, linear perfluoronated alkenes, linear alkynes, non-aromatic rings, non-aromatic heterocycles, aromatic rings, or aromatic heterocycles. In some embodiments, the substitution of the aromatic monomers may include, but are not limited to, any one or combination of the following: a phenyl ring, a napthyl ring, an anthracene ring, a thiophene ring system, a furan ring system, a pyrrole ring system, a carbazole ring system, a fluorene ring system, a pyridine ring system, a benzothiadiazole ring system, a thieno[3,4-b]pyrazine ring system, a furo[3,4-b]pyrazine ring system, a benzo[2,1-b:3,4-b′]dithiophene-4,5-dione ring system, a quinoxaline ring system, a isoindoline-1,3-dione ring system, a pyrrolo[3,4-f]isoindole-1,3,5,7(2H,6H)-tetraone ring system, a benzo[lmn][3,8]phenanthroline-1,3,6,8(2H,7H)-tetraone ring system, a benzo[1,2-b:4,5-b′]difuran-4,8-dione ring system, a benzo[1,2-b:4,5-b′]dithiophene-4,8-dione ring system, a p-benzoquinone ring system, a o-benzoquinone ring system, a naphthalene-1,4-dione ring system, or a phenanthrene-9,10-dione ring system.

In some embodiments, the polymer may accept or provide electrons to facilitate the reduction and/or oxidation of the redox-active material, respectively.

In some embodiments, the polymer may help facilitate transfer and/or release monovalent or multivalent ions from the redox-active material particles during electrochemical cycling.

In some embodiments, the polymer may also help store and/or release monovalent or multivalent ions during electrochemical cycling. In some embodiments, the polymer may store, release, and/or help facilitate transfer of cations such as, but not limited to hydrogen, lithium, sodium, potassium, cesium, magnesium, calcium, and barium during electrochemical cycling.

Processing of the polymer-coated redox-active particles into an active electrode is described. Electrode function and fabrication is described. An electrode may be designed as an anode or a cathode in a secondary battery system. Upon discharge, an electron is displaced from the active anode material and transferred to the active cathode material. Upon charge, an electron is displaced from the active cathode material and transferred to the active anode material. In some embodiments, the active anode material may be one or any combination of the following materials: the redox-active particle or the polymer. In some embodiments, the active cathode material may be one or any combination of the following materials: the redox-active particle or the polymer. In some embodiments, an electrode may comprise a current collector, a polymer-coated redox-active particle, conductive additives, and polymer additives. In some embodiments, the current collector used may be, but is not limited to, titanium, zirconium, aluminum, copper, nickel, carbon, or stainless steel. In some embodiments, polymer additives used may include, but are not limited to, styrene-butadiene rubber, poly(vinylidene fluoride), poly(tetrafluoroethylene), polyacrylic acid, poly(methyl methacrylate) carboxymethyl cellulose, carboxyethyl cellulose, hydroxyethyl cellulose, or hydroxypropyl cellulose.

In some embodiments, the active material for electrodes in a secondary battery system may be processed by means of solid coating, slurry coating, or thermal evaporation. In some embodiments, slurry deposition to the current collector may be performed by means of doctor blading, slot-die coating, reverse roll coating, gravure coating, knife-over-roll coating, comma coating, or any other method of coating known to those skilled in the art. In some embodiments, the redox-active polymer may undergo ex-situ or in-situ electrochemical activation prior to cell fabrication and/or operation. In some embodiments, one or both electrodes in the energy storage system may contain redox-active polymer materials as the active layer. In some embodiments, the solids concentration of active material to all solids used in an electrode mixture may range from but is not limited to 20-98%.

The components of the secondary battery energy storage system electrolyte are described while in no way limiting the mechanism or theory of the system. In some embodiments, electrodes may be introduced into an electrolytic solution which may contain any one or combination of the stereoisomeric proton-donor/proton-transfer materials such as, but not limiting to: acetic acid, benzoic acid, formic acid, gluconic acid, oxalic acid, oxamic acid, oxalamide, butanedioic acid, 2-hydroxybutanedioic acid, 2-hydroxypropane-1,2,3-tricarboxylic acid 2-hydroxypropanoic acid, 2,3-dihydroxybutanedioic acid, (2E)-but-2-enoic acid, pyridine-2-carboxylic acid, pyridine-2,6-dicarboxylic acid, pyridine-3-carboxylic acid, pyridine-3,5-dicarboxylic acid, pyridine-4-carboxylic acid, (methylamino)acetic acid, (dimethylamino)acetic acid, pyridine-2-sulfonic acid, pyridine-3-sulfonic acid, pyridin-2-ylmethylamine, pyridin-3-ylmethylamine, amino(oxo)methanesulfonic acid, 2-oxo-2-(phenylamino)acetic acid, N1-phenyloxalamide, oxo(phenylamino)methanesulfonic acid, L-Arginine, L-Histidine, L-Alanine, L-Proline, aminoacetic acid, phosphoric acid, boric acid, sulfuric acid, nitric acid, phosphoric acid hydrochloric acid, hydrobromic acid, hydroiodic acid, or salts of aluminum, vanadium, manganese, iron, copper, zinc, gallium, bismuth, or any other organic acids, inorganic acids, or metal salts which liberate a metal ion possessing properties of a classical, Lewis, or Bronsted acid.

In some embodiments, electrodes may be introduced into an electrolytic solution which may contain inorganic or organic salts, where the cation composition may be, but is not limited to: lithium, sodium, potassium, cesium, magnesium, calcium, barium, aluminum, zirconium, vanadium, chromium, molybdenum, tungsten, manganese, iron, cobalt, iridium, nickel, copper, silver, gold, zinc, phosphonium, ammonium, tetraalkylammonium, imidazolium, pyridinium, and isoquinolinium ions. In some embodiments, electrodes may be introduced into an electrolytic solution which may contain inorganic or organic salts, where the anion composition may be, but is not limited to, sulfate, sulfonates, phosphates, acetate, formates, nitrate, hexavalent phosphates, hydroxides, fluorides, chlorides, bromides, and iodides. In some embodiments, the solvent used to make electrolytes may be water. In some embodiments, the solvents used to make electrolytes may be organic in nature, where examples include, but are not limited to: N-methylpyrrolidone, acetonitrile, N,N-dimethylformamide, N,N-dimethylacetamide, tetrahydrofuran, dimethyl carbonate, and propylene carbonate. In some embodiments, electrodes may be introduced into an electrolytic solution at different pH ranges including, but not limited to: 0 to 3, 0 to 7, 3-10, 10-14, or 7-14.

In some embodiments, redox active materials (e.g., redox active particles), may be functionalized with a polymeric coating (e.g., an encapsulant). In some embodiments, redox active materials may be suspended into a solution of basified or acidified solvent, which may be, but does not limit the selection to, water. In some embodiments, redox active materials include, but are not limited to, manganese, vanadium, iron, tungsten, molybdenum, tin, or titanium. In some embodiments, monomers may be first chemically bound to the surface of the redox active particle. Exemplary monomers include, but are not limited to, the chemical binding of aniline or pyrrole to the redox particle surface. In some embodiments, oxidants, initiators, or other polymerization-inducing compounds, may be added to solutions in a controlled fashion, chemically growing the polymer strands off the redox active materials. Exemplary oxidants, initiators, or other polymerization-inducing compounds include, but are not limited to, iron chloride, potassium persulfate, or ammonium persulfate. In some embodiments, redox active material/encapsulant products can be isolated via filtration.

The following is an example of how an electrochemical cell may be prepared from the resulting electrode bearing the redox active material and encapsulant, according to conventional methods in the art. In some embodiments, two or more of any combination of the following may be mixed to form a slurry: an aliquot of active material and encapsulant, an aliquot of conductive additive, an aliquot of binder material, an aliquot of rheology modifier, solvent, an aliquot of pH adjusting reagent, or a pH adjusting solution. In some embodiments, the resulting mixture may be coated onto a current collector or substrate. In some embodiments, the resulting electrode may be cured at elevated temperatures. In many embodiments, a first electrode may be paired with a second electrode. In many embodiments, the two electrodes may be isolated from one another using a separator material. In some embodiments, separators may be, but is not limited to, the following materials: polypropylene, polyethylene, polyacrylates, polyterephthalate, cellulose, polyethersulfone, silicon oxide, aluminum oxide, titanium oxide, or any other electrically insulating material. In some embodiments, electrodes may be welded to a conductive material to serve as an electrode contact. In some embodiments, electrodes may be placed into an isolated, insulated container of any shape. In some embodiments, other components such as, but not limited to, adhesives may be, but are not required to be, added to the container and its contents to preserve the structural integrity of the electrochemical cell. In some embodiments, the container and contents may be wetted with an electrolytic solution. In some embodiments, the full content of the container may be, but is not required to be, purged from atmosphere, and sealed.

Polymer coated redox active materials may improve certain characteristics of electrochemical cells which contain them. Such improved cell characteristics may include but are not limited to higher average discharge voltage, longer cycle life, higher specific capacity, improved voltaic efficiency, improved coulombic efficiency, or improved rate capability.

IV. Polymer-Coated Redox-Active Particles and their Uses in Secondary Battery Systems

Polymer-coated redox-active particles for use as redox-active materials in secondary battery systems electrodes are described. In some embodiments, the particles are metal containing. In some embodiments, electrodes comprise a conductive or semi-conductive polymer which is mechanically applied to the redox-active particles through engineering methods or grown via a chemical reaction(s) on the surface of the particles. In some embodiments, the polymer may be organic or organometallic in composition.

The redox-active particles of the polymer redox-active particles are described. In some embodiments, the metal composition of the redox-active particle may be, but is not limited to: lithium, tin, zinc, tungsten, manganese, molybdenum, titanium, iron, vanadium, or some combination thereof. The metal may be present as halides, hydroxides, oxides, phosphates, suboxides, nitrates, nitrites, sulfates, sulfides, chlorates, bromates, iodates, or elements. In some embodiments, the redox-active particles may be doped with metals such as, but not limited to, aluminum, yttrium, tin, copper, cobalt, zinc, silver, gold, iron, chromium, sodium, potassium, cesium, magnesium, calcium, or barium. In some embodiments, the doping concentration may be less than 15%. In some embodiments, the particle size of the redox active particle may have a particle size distribution where the d99 is less than 100 microns.

In some embodiments, the polymers of the polymer-coated redox-active particles may be of the following classifications: linear, branched, or cross-linked. In some embodiments, the polymers of the polymer-coated redox-active particles may be of the following sub-classifications: homopolymers, alternating co-polymers, periodic co-polymers, random co-polymers, block co-polymers, graft co-polymers, gradient co-polymers. In some embodiments, the polymers of the polymer-coated redox-active particles may be applied to the redox active particle in thicknesses ranging between, but are not limited to, 2 nm-50,000 nm. In some embodiments, the polymers may include, but are not required to include, one or more aromatic heterocyclic monomers. In some embodiments, the polymers of the polymer-coated redox-active particles include, but are not limited to, homopolymers. In some embodiments, monomers used to form the polymer of the polymer-coated redox-active particles may be, but are not limited to, the following in composition: linear hydrocarbons, perfluorinated hydrocarbons, substituted hydrocarbons, cyclic hydrocarbons, cyclic perfluorinated hydrocarbons, substituted hydrocarbons, linear alkenes, linear perfluoronated alkenes, linear substituted alkenes, linear alkynes, aromatic heterocycles, or substituted aromatic heterocycles or combinations thereof. Examples of aromatic units may be, but are not limited to: a phenyl ring, a naphthyl ring, an anthracene ring, a thiophene ring system, a furan ring system, a pyrrole ring system, a carbazole ring system, a fluorene ring system, a pyridine ring system, a benzothiadiazole ring system, a thieno[3,4-b]pyrazine ring system, a furo[3,4-b]pyrazine ring system, a benzo[2,1-b:3,4-b′]dithiophene-4,5-dione ring system, a quinoxaline ring system, a isoindoline-1,3-dione ring system, a pyrrolo[3,4-f]isoindole-1,3,5,7(2H,6H)-tetraone ring system, a benzo[lmn][3,8]phenanthroline-1,3,6,8(2H,7H)-tetraone ring system, a benzo[1,2-b:4,5-b′]difuran-4,8-dione ring system, a benzo[1,2-b:4,5-b′]dithiophene-4,8-dione ring system, a p-benzoquinone ring system, a o-benzoquinone ring system, a naphthalene-1,4-dione ring system, a phenanthrene-9,10-dione ring system. In some embodiments, the monomers, polymers, or copolymers may include, but are not limited to, pyrrole, thiophene, and aniline. In some embodiments, the alkyl units may be covalently bonded to materials such as, but not limiting to: an ethyl group, a propyl group, a butyl group, a hexyl group, a glycol group, an imine group, and a sulfonyl group.

The substitution of the polymers is described. In some embodiments, the substitution of the alkyl monomers may include, but are not limited to, any one or combination of the following: a hydrogen atom, linear hydrocarbons, perfluorinated hydrocarbons, cyclic hydrocarbons, cyclic perfluorinated hydrocarbons, alkoxy-groups, alkyl-sulfide groups, monoalkyl-amines, dialkyl-amines, alkylsulfonic acid groups, alkylphosphonic acid groups, alkylimidazolium groups, alkylpyridinium groups, or alkyl(trialkylammonium) groups, linear alkenes, linear perfluoronated alkenes, linear alkynes, non-aromatic rings, non-aromatic heterocycles, aromatic rings, or aromatic heterocycles. In some embodiments, the substitution of the aromatic monomers may include, but are not limited to, any one or combination of the following: a phenyl ring, a napthyl ring, an anthracene ring, a thiophene ring system, a furan ring system, a pyrrole ring system, a carbazole ring system, a fluorene ring system, a pyridine ring system, a benzothiadiazole ring system, a thieno[3,4-b]pyrazine ring system, a furo[3,4-b]pyrazine ring system, a benzo[2,1-b:3,4-b′]dithiophene-4,5-dione ring system, a quinoxaline ring system, a isoindoline-1,3-dione ring system, a pyrrolo[3,4-f]isoindole-1,3,5,7(2H,6H)-tetraone ring system, a benzo[lmn][3,8]phenanthroline-1,3,6,8(2H,7H)-tetraone ring system, a benzo[1,2-b:4,5-b′]difuran-4,8-dione ring system, a benzo[1,2-b:4,5-b′]dithiophene-4,8-dione ring system, a p-benzoquinone ring system, a o-benzoquinone ring system, a naphthalene-1,4-dione ring system, or a phenanthrene-9,10-dione ring system.

In some embodiments, the polymer may accept or provide electrons to facilitate the reduction and/or oxidation of the redox-active material, respectively.

In some embodiments, the polymer may help facilitate transfer and/or release monovalent or multivalent ions from the redox-active material particles during electrochemical cycling.

In some embodiments, the polymer may also help store and/or release monovalent or multivalent ions during electrochemical cycling. In some embodiments, the polymer may store, release, and/or help facilitate transfer of cations such as, but not limited to hydrogen, lithium, sodium, potassium, cesium, magnesium, calcium, and barium during electrochemical cycling.

Processing of the polymer-coated redox-active particles into an active electrode is described. Electrode function and fabrication is described. An electrode may be designed as an anode or a cathode in a secondary battery system. Upon discharge, an electron is displaced from the active anode material and transferred to the active cathode material. Upon charge, an electron is displaced from the active cathode material and transferred to the active anode material. In some embodiments, the active anode material may be one or any combination of the following materials: the redox-active particle or the polymer. In some embodiments, the active cathode material may be one or any combination of the following materials: the redox-active particle or the polymer. In some embodiments, an electrode may comprise a current collector, a polymer-coated redox-active particle, conductive additives, and polymer additives. In some embodiments, the current collector used may be, but is not limited to, titanium, zirconium, aluminum, copper, nickel, carbon, or stainless steel. In some embodiments, polymer additives used may include, but are not limited to, styrene-butadiene rubber, poly(vinylidene fluoride), poly(tetrafluoroethylene), polyacrylic acid, poly(methyl methacrylate) carboxymethyl cellulose, carboxyethyl cellulose, hydroxyethyl cellulose, or hydroxypropyl cellulose.

In some embodiments, the active material for electrodes in a secondary battery system may be processed by means of solid coating, slurry coating, or thermal evaporation. In some embodiments, slurry deposition to the current collector may be performed by means of doctor blading, slot-die coating, reverse roll coating, gravure coating, knife-over-roll coating, comma coating, or any other method of coating known to those skilled in the art. In some embodiments, the redox-active polymer may undergo ex-situ or in-situ electrochemical activation prior to cell fabrication and/or operation. In some embodiments, one or both electrodes in the energy storage system may contain redox-active polymer materials as the active layer. In some embodiments, the solids concentration of active material to all solids used in an electrode mixture may range from but is not limited to 20-98%.

The components of the secondary battery energy storage system electrolyte are described while in no way limiting the mechanism or theory of the system. In some embodiments, electrodes may be introduced into an electrolytic solution which may contain any one or combination of the stereoisomeric proton-donor/proton-transfer materials such as, but not limiting to: acetic acid, benzoic acid, formic acid, gluconic acid, oxalic acid, oxamic acid, oxalamide, butanedioic acid, 2-hydroxybutanedioic acid, 2-hydroxypropane-1,2,3-tricarboxylic acid 2-hydroxypropanoic acid, 2,3-dihydroxybutanedioic acid, (2E)-but-2-enoic acid, pyridine-2-carboxylic acid, pyridine-2,6-dicarboxylic acid, pyridine-3-carboxylic acid, pyridine-3,5-dicarboxylic acid, pyridine-4-carboxylic acid, (methylamino)acetic acid, (dimethylamino)acetic acid, pyridine-2-sulfonic acid, pyridine-3-sulfonic acid, pyridin-2-ylmethylamine, pyridin-3-ylmethylamine, amino(oxo)methanesulfonic acid, 2-oxo-2-(phenylamino)acetic acid, N1-phenyloxalamide, oxo(phenylamino)methanesulfonic acid, L-Arginine, L-Histidine, L-Alanine, L-Proline, aminoacetic acid, phosphoric acid, boric acid, sulfuric acid, nitric acid, phosphoric acid hydrochloric acid, hydrobromic acid, hydroiodic acid, or salts of aluminum, vanadium, manganese, iron, copper, zinc, gallium, bismuth, or any other organic acids, inorganic acids, or metal salts which liberate a metal ion possessing properties of a classical, Lewis, or Bronsted acid. In some embodiments, electrodes may be introduced into an electrolytic solution which may contain inorganic or organic salts, where the cation composition may be, but is not limited to: lithium, sodium, potassium, cesium, magnesium, calcium, barium, aluminum, zirconium, vanadium, chromium, molybdenum, tungsten, manganese, iron, cobalt, iridium, nickel, copper, silver, gold, zinc, phosphonium, ammonium, tetraalkylammonium, imidazolium, pyridinium, and isoquinolinium ions. In some embodiments, electrodes may be introduced into an electrolytic solution which may contain inorganic or organic salts, where the anion composition may be, but is not limited to, sulfate, sulfonates, phosphates, acetate, formates, nitrate, hexavalent phosphates, hydroxides, fluorides, chlorides, bromides, and iodides. In some embodiments, the solvent used to make electrolytes may be water. In some embodiments, the solvents used to make electrolytes may be organic in nature, where examples include, but are not limited to: N-methylpyrrolidone, acetonitrile, N,N-dimethylformamide, N,N-dimethylacetamide, tetrahydrofuran, dimethyl carbonate, and propylene carbonate. In some embodiments, electrodes may be introduced into an electrolytic solution at different pH ranges including, but not limiting to: 0 to 3, 0 to 7, 3-10, 10-14, or 7-14.

For example, redox active materials (e.g., redox active particles) may be functionalized with a polymeric coating (e.g., an encapsulant). In some embodiments, redox active materials may be suspended into a solution of basified or acidified solvent, which may be, but is not limited to, water. Exemplary redox active materials include, but are not limited to, manganese, vanadium, iron, tungsten, molybdenum, tin, or titanium. In some embodiments, monomers may be first chemically bound to the surface of the redox active materials (e.g., redox active particles). Exemplary monomers include, but are not limited to, aniline or pyrrole to the redox particle surface. Oxidants, initiators, or other polymerization inducing species, may be added in a controlled fashion, chemically growing the polymer strands off the redox active materials (e.g., redox active particles). Exemplary oxidants, initiators, or other polymerization inducing species include, but are not limited to, iron chloride, potassium persulfate, or ammonium persulfate. In some embodiments, redox active materials/encapsulant products can be isolated via filtration.

The following is an example of how an electrochemical cell may be prepared from the resulting electrode bearing the redox active material and encapsulant, according to conventional methods in the art. In some embodiments, two or more of any combination of the following may be mixed to form a slurry: an aliquot of active material and encapsulant, an aliquot of conductive additive, an aliquot of binder material, an aliquot of rheology modifier, solvent, an aliquot of pH adjusting reagent, or a pH adjusting solution. In some embodiments, the resulting mixture may be coated onto a current collector or substrate. In some embodiments, the resulting electrode may be cured at elevated temperatures. In many embodiments, a first electrode may be paired with a second electrode. In many embodiments, the two electrodes may be isolated from one another using a separator material. In some embodiments, separators may be, but are not limited to, the following materials: polypropylene, polyethylene, polyacrylates, polyterephthalate, cellulose, polyethersulfone, silicon oxide, aluminum oxide, titanium oxide, or any other electrically insulating material. In some embodiments, electrodes may be welded to a conductive material to serve as an electrode contact. In some embodiments, electrodes may be placed into an isolated, insulated container of any shape. In some embodiments, other components such as, but not limited to, adhesives may be, but are not required to be, added to the container and its contents to preserve the structural integrity of the electrochemical cell. In some embodiments, the container and contents may be wetted with an electrolytic solution. In some embodiments, the full content of the container may be, but is not required to be, purged from atmosphere, and sealed.

Polymer coated redox active materials may improve certain characteristics of electrochemical cells without being bound by specific theory or mechanism. Improved cell characteristics may include but are not limited to higher average discharge voltage, longer cycle life, higher specific capacity, improved voltaic efficiency, improved coulombic efficiency, or improved rate capability.

### V. Enabling Operational Temperature Ranges in the Energy Storage System

Expanding the operational temperature range of the battery storage technology described herein, to operate between −20° C. and 60° C. (for example, between −5° C. and 45° C.) through routes including but not limiting to absorbing or releasing heat into redox inactive materials inside a cell (such as in electrolytes, in a separator, or one or both electrodes), absorbing or releasing heat into redox inactive materials outside cell (such as between cells within a module), introducing catalysts and/or dopants to inhibit or improve certain reactions that may occur faster or slower at higher and lower temperatures respectively, selecting inactive electrode components (such as conductive additives, binders) that do not undergo side reactions at elevated temperatures, and controlling the ionic conductivity at lower or higher temperatures to maintain an optimum diffusion rate of ions.

In some embodiments, phase change additives are introduced into electrodes. Phase change additives may include organic and inorganic compounds that undergo a phase change (solid to liquid, liquid to solid) within the operating temperature range of −20° C. and 60° C. (for example, between 35° C. and 45° C.). In some embodiments, phase change additives may also undergo a phase change from one crystal structure to another (solid to solid). Phase change additives may be further encapsulated within an encapsulant, wherein the encapsulant prevents leakage of the additive and is sufficiently thermally conductive.

Phase change additives, which may or may not include an encapsulant, maybe incorporated into an electrode slurry with a weight distribution from 0.01 wt. % to 50 wt. % (for example, between 0.1 wt. % and 5 wt. %, e.g., about 0.1 wt %, about 0.2 wt %, about 0.5 wt %, about 1 wt %, about 2 wt %, about 3 wt %, about 4 wt %, about 5 wt %), or introduced as a precoat on the current collector, wherein phase change additives constitutes 0.01 wt. % up to 98 wt. % of the weight distribution (for example, between 0.1 wt. % and 5 wt. %, e.g., about 0.1 wt %, about 0.2 wt %, about 0.5 wt %, about 1 wt %, about 2 wt %, about 3 wt %, about 4 wt %, about 5 wt %). Phase change additives, which may or may not include an encapsulant, may also be coated as a thin film on one or both electrodes, wherein the thin film comprises between 0.01 wt. % and 98 wt. % of phase change additives (for example, between 0.1 wt. % and 5 wt. %, e.g., about 0.1 wt %, about 0.2 wt %, about 0.5 wt %, about 1 wt %, about 2 wt %, about 3 wt %, about 4 wt %, about 5 wt %). Phase change additives may also be coated on the active electrode particles as an encapsulant or be coated with the active electrode particles wherein the active electrode particles act as the encapsulant, and phase change additives constitutes the inner core. When a phase change additive serves as an encapsulant or the inner core, the composition can range between 0.01 wt. % up to 98 wt. % (e.g., about 0.01 wt %, about 0.1 wt %, about 0.2 wt %, about 0.3 wt %, about 0.5 wt %, about 1 wt %, about 2 wt %, about 3 wt %, about 4 wt %, about 5 wt %, about 10 wt %, about 20 wt %, about 30 wt %, about 40 wt %, about 50 wt %, about 60 wt %, about 70 wt %, about 80 wt %, about or 90 wt %) of phase change additives. Finally, phase change additives may also be incorporated into a separator, either as particles integrated into the separator, or as thin films on one or both sides of the separator.

In some embodiments, phase change additives as described above are used to coat the casing of a cell (such as aluminum laminate in the pouch) and/or placed in the void between cells inside a module.

In some embodiments, the electrochemical cell is operated within a voltage window that avoids the onset potential of undesirable side reactions including but not limited to hydrogen evolution reaction and oxygen evolution reaction.

In some embodiments, electrodes comprise binders or emulsifiers that are stable at higher temperatures either due to composition or through cross-linking or other passivation pre-treatments. Examples of such binders or emulsifiers include but are not limited to polyvinylidene fluoride (PVDF), polytetrafluoroethylene (PTFE), polyvinyl alcohol, polyacrylic acid, alginates, polyamides, polyimides, polyesters, polyalkyds, polyacrylates, polyurethanes, acrylonitriles, polyvinylpyrrolidone (PVP), polyvinyl acetate, polyvinyl chloride (PVC), carboxymethyl cellulose (CMC), hydroxypropyl cellulose (HPC), hydroxyethyl cellulose (HEC), and/or styrene butadiene rubber (SBR). In some embodiments, binder concentration ranges between about 0.1 wt. % and about 25 wt. %. For example, binder concentration may be about 0.1 wt %, about 0.5 wt %, about 1 wt %, about 5 wt %, about 10 wt %, about 15 wt %, about 20 wt %, or about 25 wt %.

In some embodiments, one or both electrodes are subject to doping in order to inhibit undesirable side reactions such as dissolution and hydrogen evolution reaction. The active electrode material includes a metal from the list comprising one, more or a combination of manganese, vanadium, iron, tungsten, molybdenum, titanium, tin, lithium, sodium, potassium, magnesium, calcium, zinc, or aluminum. The active electrode is in the form of one or more or a combination of halides, hydroxides, oxides, phosphates, suboxides, nitrates, nitrites, sulfates, sulfides, chlorates, bromates, and/or iodates. Dopants may include one, more or a combination of hydrogen, lithium, sodium, potassium, calcium, bismuth, cesium, titanium, tin, zirconium, yttrium, hafnium, vanadium, tantalum, niobium, indium, iron, manganese, zinc, cobalt, nickel, nitrogen, lanthanum, and copper. A dopant is present in a concentration ranging between 0.01 wt. % and 21 wt. %, preferably between 0.1 wt. % and 10 wt. % (e.g., about 0.1 wt %, about 0.2 wt %, about 0.5 wt %, about 1 wt %, about 2 wt %, about 3 wt %, about 4 wt %, about 5 wt %, about 7 wt %, about 10 wt %).

In some embodiments, electrode-electrolyte interface stability is improved by encapsulating electrode particles within a thermally stable encapsulant (for example, a polymer, a ceramic, a metal, a metal oxide). In some embodiments, the encapsulant is also corrosion resistant. In some embodiments, the encapsulant is also stable in the electrochemical environment. In some embodiments, the encapsulant is an inactive material in the electrochemical environment, that is, do not actively store or release ions.

In some embodiments, electrolytes of the energy storage system comprises one or more additives that do one or a combination of intentionally reducing the ionic mobility in electrolytes, intentionally increasing the viscosity of electrolytes, intentionally delaying oxygen or hydrogen evolution reaction, or intentionally impeding dissolution of electrode. Electrolytes may comprise one, more, or a combination of halides, hydroxides, oxides, phosphates, oxyphosphates, suboxides, nitrates, nitrites, sulfates, sulfides, chlorates, cyanides, bromates, or iodates, of vanadium, manganese, magnesium, lithium, sodium, potassium, iron, zinc, aluminum, silver, tin, cerium, bismuth. Electrolytes may further comprise one or more or a combination of gluconic acid, oxalic acid, niacin, picolinic acid, oxamic acid, oxalamide, butanedioic acid, 2-hydroxybutanedioic acid, 2-hydroxypropane-1,2,3-tricarboxylic acid 2-hydroxypropanoic acid, 2,3-dihydroxybutanedioic acid, (2E)-but-2-enoic acid, pyridine-2-carboxylic acid, pyridine-2,6-dicarboxylic acid, acetic acid, benzoic acid, urea, polyethylene glycol, sucrose, fructose, acetonitrile, pyridine-3-carboxylic acid, pyridine-3,5-dicarboxylic acid, pyridine-4-carboxylic acid, (methylamino)acetic acid, (dimethylamino)acetic acid, pyridine-2-sulfonic acid, pyridine-3-sulfonic acid, pyridin-2-ylmethylamine, pyridin-3-ylmethylamine, amino(oxo)methanesulfonic acid, 2-oxo-2-(phenylamino)acetic acid, N1-phenyloxalamide, oxo(phenylamino)methanesulfonic acid, L-Arginine, L-Histidine, L-Alanine, L-Proline, aminoacetic acid, phosphoric acid, boric acid. The concentration of each of the one or more additives may range from a minimum of 0.01M to a maximum of 5M.

### VI. Aqueous Electrochemical Cells

As presented herein, electrochemical cells (e.g., aqueous electrochemical cells) may comprise a positive electrode (e.g., a cathode), a negative electrode (e.g., an anode), a separator disposed between an anode and a cathode to physically and electrically isolate the two electrodes, and an electrolyte. An electrochemical cell comprises an electrolyte containing a weak acid and at least one electrode that stores/releases positively charged hydrogen ions as charge carriers during cycling.

In some embodiments, electrodes comprise a redox active material, polymer additives, and/or conductive additives applied to a conductive substrate, also called a current collector. The redox active material on either a cathode or an anode may include one or more selected from the group consisting of: halides, hydroxides, oxides, cyanides, phosphates, oxyphosphates, suboxides, nitrates, nitrites, sulfates, sulfides, chlorates, bromates, iodates, or elemental forms of a metal. The metal may be silicon, titanium, vanadium, chromium, manganese, magnesium, lithium, sodium, potassium, iron, cobalt, nickel, copper, zinc, germanium, aluminum, gallium, zirconium, niobium, molybdenum, ruthenium, silver, cadmium, indium, tin, antimony, lanthanum, cerium, neodymium, tantalum, tungsten, rhenium, platinum, gold, lead, strontium, bismuth, mercury, and a combination thereof. In some embodiments, the redox active material is present in the form of particles.

In some embodiments, redox active materials comprise a polymer capable of storing and releasing ions during electrochemical cycling. In some embodiments, the redox active material is present partially or fully as dissolved ions in electrolytes capable of undergoing a deposition/dissolution process to store charge on either an anode or cathode, or both, during cycling. In some embodiments, a cathode redox active material contains manganese, vanadium, or iron. In some embodiments, an anode redox active material contains tungsten, zinc, molybdenum, tin, or titanium. Polymer additives may include, for example, polyvinylidene fluoride (PVDF), polytetrafluoroethylene (PTFE), polyvinyl alcohol, polyacrylic acid, alginates, polyamides, polyimides, polyesters, polyalkyds, polyacrylates, polyurethanes, acrylonitriles, polyvinylpyrrolidone (PVP), polyvinyl acetate, polyvinyl chloride (PVC), carboxymethyl cellulose (CMC), hydroxypropyl cellulose (HPC), hydroxyethyl cellulose (HEC), and/or styrene butadiene rubber (SBR). Conductive additives may include carbon black, acetylene black, carbon fibers, carbon nanotubes, graphene, graphite, a fullerene, a carbon aerogel, metal flakes, metal fibers, and/or metal particles. In many embodiments, at least one of electrodes stores and releases positively charged hydrogen ions during electrochemical cycling.

a. Separators

Separators may comprise one or more members selected from the group consisting of aniline, polyaniline, polypyrrole, polythiophene, polyethylene, polypropylene, polyethersulfone, sulfonated tetrafluoroethylene (Nafion), perfluorosulfonic acid, cellulose, sodium, lithium, potassium, calcium, manganese, magnesium, neodymium, praseodymium, yttrium, europium, gadolinium, scandium, aluminum, an aluminum oxide, tin, a tin oxide, titanium, a titanium oxide, a titanium carbide, silicon, a silicon oxide, a silicon carbide, a silicon nitride, a silicon aluminum oxynitride, zinc, a zinc oxide, iron, ferrites, cerium, a cerium oxide, hydrogen, water molecules, lanthanum, a lanthanum oxide, tungsten, a tungsten carbide, boron, a boron oxide, a boron nitride, zirconium, a zirconium oxide, a compound of composition M_{y}AlₓSi₁₋ₓO₂·zH₂O, where M is a metal, or a combination thereof. Separators may be a freestanding film disposed between the two electrodes or may be an electrically insulating film applied to the surface of one or both electrodes. In some embodiments, the film may comprise particles or fibers along with polymer additives such as, for example, polyvinylidene fluoride (PVDF), polytetrafluoroethylene (PTFE), polyvinyl alcohol, polyvinylpyrrolidone (PVP), polyvinyl acetate, polyvinyl chloride (PVC), carboxymethyl cellulose (CMC), hydroxypropyl cellulose (HPC), hydroxyethyl cellulose (HEC), styrene butadiene rubber (SBR).

b. Electrolytes

In some embodiments, electrolytes comprise water. Electrolytes may contain dissolved salts or organic cosolvents. In some embodiments, electrolytes has a pH of 7 or less, preferably less than 4. In some embodiments, electrolytes contains a material capable of acting as a weak Bronsted-Lowry or Lewis acid. Weak acids may include but are not limited to formic acid, gluconic acid, oxalic acid, niacin, picolinic acid, oxamic acid, oxalamide, butanedioic acid, 2-hydroxybutanedioic acid, 2-hydroxypropane-1,2,3-tricarboxylic acid 2-hydroxypropanoic acid, 2,3-dihydroxybutanedioic acid, (2E)-but-2-enoic acid, pyridine-2-carboxylic acid, pyridine-2,6-dicarboxylic acid, acetic acid, benzoic acid, pyridine-3-carboxylic acid, pyridine-3,5-dicarboxylic acid, pyridine-4-carboxylic acid, (methylamino)acetic acid, (dimethylamino)acetic acid, pyridine-2-sulfonic acid, pyridine-3-sulfonic acid, pyridin-2-ylmethylamine, pyridin-3-ylmethylamine, amino(oxo)methanesulfonic acid, 2-oxo-2-(phenylamino)acetic acid, N1-phenyloxalamide, oxo(phenylamino)methanesulfonic acid, L-Arginine, L-Histidine, L-Alanine, L-Proline, aminoacetic acid, phosphoric acid, boric acid, or salts of aluminum, vanadium, manganese, iron, copper, zinc, gallium, bismuth, or any other organic acids, inorganic acids, or metal salts which liberate a metal ion possessing properties of a classical, Lewis, or Bronsted acid.

c. Aqueous Electrochemical Cell Cycling

The functioning of the electrochemical system is described as follows. Upon discharge, an electron, or electrons are displaced from the active anode material and transferred to the active cathode material. Concurrently, the charge storage ions may de-intercalate from the active anode material and intercalate into a cathode active material. Upon charge, an electron is displaced from the active cathode material and transferred to the active anode material. Concurrently, the charge storage ions may de-intercalate from the active cathode material and intercalate into an anode active material. Intercalation is defined as charge storage within an active material and de-intercalation is defined as the ion leaving the active material.

Certain embodiments of the present disclosure were described above. It is, however, expressly noted that the present disclosure is not limited to those embodiments, but rather the intention is that additions and modifications to what was expressly described in the present disclosure are also included within the scope of the disclosure. Moreover, it is to be understood that the features of the various embodiments described in the present disclosure were not mutually exclusive and can exist in various combinations and permutations, even if such combinations or permutations were not made express, without departing from the spirit and scope of the disclosure. The disclosure has been described in detail with particular reference to certain embodiments thereof, but it will be understood that variations and modifications can be effected within the spirit and scope of the claimed invention.

1. An electrode composition comprising an electrochemically-active polymer.

2. The electrode composition of claim 1, wherein the electrochemically-active polymer is of Formula I:

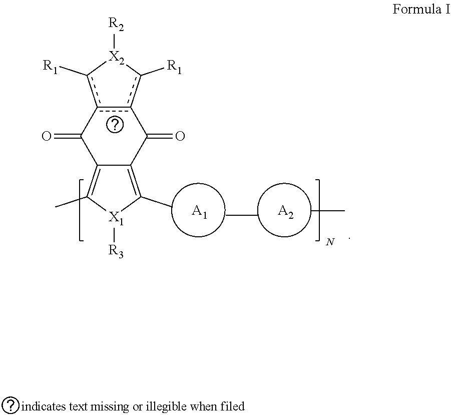

3. The electrode composition of claim 2, wherein in Formula I:
X₁ is nitrogen, oxygen, or sulfur;
X₂ is nitrogen, oxygen, or sulfur;
R₁ is hydrogen, oxygen, an alkyl group, an alkoxy group, an aminoalkyl group, a thioalkyl group, or an acetyl group;
R₂ is hydrogen, an alkyl group, an aryl group, an alkylsulfonic acid group, an alkylphosphonic acid group, an alkylimidazolium group, an alkylpyridinium group, or an alkyl(trialkylammonium) group;
R₃ is hydrogen, an alkyl group, an alkylsulfonic acid group, an alkylphosphonic acid group, an alkylimidazolium group, an alkylpyridinium group, or an alkyl(trialkylammonium) group;
A₁ is a phenyl ring, a napthyl ring, an anthracene ring, a thiophene ring system, a furan ring system, a pyrrole ring system, a carbazole ring system, a fluorene ring system, a pyridine ring system, a benzothiadiazole ring system, a thieno[3,4-b]pyrazine ring system, a furo[3,4-b]pyrazine ring system, a benzo[2,1-b:3,4-b′]dithiophene-4,5-dione ring system, a quinoxaline ring system, a isoindoline-1,3-dione ring system, a pyrrolo[3,4-f]isoindole-1,3,5,7(2H,6H)-tetraone ring system, a benzo[lmn][3,8]phenanthroline-1,3,6,8(2H,7H)-tetraone ring system, a benzo[1,2-b:4,5-b′]difuran-4,8-dione ring system, a benzo[1,2-b:4,5-b′]dithiophene-4,8-dione ring system, a p-benzoquinone ring system, an o-benzoquinone ring system, a naphthalene-1,4-dione ring system, a phenanthrene-9,10-dione ring system, or a combination thereof;
A₂ is absent or is a phenyl ring, a napthyl ring, an anthracene ring, a thiophene ring system, a furan ring system, a pyrrole ring system, a carbazole ring system, a fluorene ring system, a pyridine ring system, a benzothiadiazole ring system, a thieno[3,4-b]pyrazine ring system, a furo[3,4-b]pyrazine ring system, a benzo[2,1-b:3,4-b′]dithiophene-4,5-dione ring system, a quinoxaline ring system, a isoindoline-1,3-dione ring system, a pyrrolo[3,4-f]isoindole-1,3,5,7(2H,6H)-tetraone ring system, a benzo[lmn][3,8]phenanthroline-1,3,6,8(2H,7H)-tetraone ring system, a benzo[1,2-b:4,5-b′]difuran-4,8-dione ring system, a benzo[1,2-b:4,5-b′]dithiophene-4,8-dione ring system, a p-benzoquinone ring system, an o-benzoquinone ring system, a naphthalene-1,4-dione ring system, a phenanthrene-9,10-dione ring system, or a combination thereof.

4. The electrode composition of claim 1, wherein the electrochemically-active polymer is of Formula II:

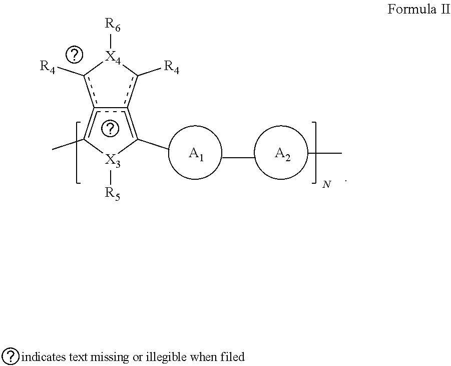

5. The electrode composition of claim 4, wherein in Formula II:
X₃ is nitrogen, oxygen, or sulfur;
X₄ is nitrogen, oxygen, or sulfur;
R₄ is hydrogen, oxygen, an alkyl group, an alkoxy group, an aminoalkyl group, a thioalkyl group, or an acetyl group;
R₆ is hydrogen, an alkyl group, an aryl group, an alkylsulfonic acid group, an alkylphosphonic acid group, an alkylimidazolium group, an alkylpyridinium group, or an alkyl(trialkylammonium) group;
R₅ is hydrogen, an alkyl group, an alkylsulfonic acid group, an alkylphosphonic acid group, an alkylimidazolium group, an alkylpyridinium group, or an alkyl(trialkylammonium) group;
A₁ is a phenyl ring, a napthyl ring, an anthracene ring, a thiophene ring system, a furan ring system, a pyrrole ring system, a carbazole ring system, a fluorene ring system, a pyridine ring system, a benzothiadiazole ring system, a thieno[3,4-b]pyrazine ring system, a furo[3,4-b]pyrazine ring system, a benzo[2,1-b:3,4-b′]dithiophene-4,5-dione ring system, a quinoxaline ring system, a isoindoline-1,3-dione ring system, a pyrrolo[3,4-f]isoindole-1,3,5,7(2H,6H)-tetraone ring system, a benzo[lmn][3,8]phenanthroline-1,3,6,8(2H,7H)-tetraone ring system, a benzo[1,2-b:4,5-b′]difuran-4,8-dione ring system, a benzo[1,2-b:4,5-b′]dithiophene-4,8-dione ring system, a p-benzoquinone ring system, an o-benzoquinone ring system, a naphthalene-1,4-dione ring system, a phenanthrene-9,10-dione ring system, or a combination thereof;
A₂ is absent or is a phenyl ring, a napthyl ring, an anthracene ring, a thiophene ring system, a furan ring system, a pyrrole ring system, a carbazole ring system, a fluorene ring system, a pyridine ring system, a benzothiadiazole ring system, a thieno[3,4-b]pyrazine ring system, a furo[3,4-b]pyrazine ring system, a benzo[2,1-b:3,4-b′]dithiophene-4,5-dione ring system, a quinoxaline ring system, a isoindoline-1,3-dione ring system, a pyrrolo[3,4-f]isoindole-1,3,5,7(2H,6H)-tetraone ring system, a benzo[lmn][3,8]phenanthroline-1,3,6,8(2H,7H)-tetraone ring system, a benzo[1,2-b:4,5-b′]difuran-4,8-dione ring system, a benzo[1,2-b:4,5-b′]dithiophene-4,8-dione ring system, a p-benzoquinone ring system, an o-benzoquinone ring system, a naphthalene-1,4-dione ring system, a phenanthrene-9,10-dione ring system, or a combination thereof.

6. An electrode comprising the electrode composition of claim 1.

7. An electrochemical cell comprising the electrode of claim 6.

8. An electrode composition for an electrochemical cell, the electrode composition comprising polymer-coated redox-active particles.

9. The electrode composition of claim 8, wherein the redox-active particles comprises a metal-containing species.

10. The electrode composition of claim 9, wherein the metal-containing species is a halide, a hydroxide, an oxide, a phosphate, a suboxide, a nitrate, a nitrite, a sulfate, a sulfide, a chlorate, a bromate, or an iodate.

11. The electrode composition of claim 9, wherein the metal-containing species is an elemental metal.

12. The electrode composition of claim 9, wherein the metal-containing species comprises lithium, tin, zinc, tungsten, manganese, molybdenum, titanium, iron, vanadium, or a combination thereof.

13. An electrode comprising the electrode composition of claim 8.

14. An electrochemical cell comprising the electrode of claim 13.

15. A method of operating an electrochemical cell in a temperature range of −20° C. to 60° C., the method comprising: absorbing or releasing heat into redox inactive materials inside the cell, absorbing or releasing heat into redox inactive materials outside the cell, inhibiting or improving one or more reactions via one or more catalysts and/or dopants in the cell, and/or controlling ionic conductivity at lower or higher temperature via one or more redox inactive electrode components in the cell.

16. An electrochemical cell comprising an electrode comprising a phase change additive.

17. The cell of claim 16, wherein the phase change additive is an encapsulated species.

18. An electrochemical cell comprising an electrode comprising a binder or emulsifier, wherein the binder or emulsifier is cross-linked or has been passivated such that the binder is stable at relatively higher temperature.

19. An electrochemical cell comprising an electrode comprising redox active particles coated with a thermally stable encapsulant.

20. The cell of claim 19, wherein the encapsulant is a polymer, a ceramic, a metal, or a metal oxide.
